(19) United States
(12) Patent Application Publication
(10) Pub. No.: US 2026/0038963 A1
(43) Pub. Date: Feb. 5, 2026

(54) BATTERY MODULE WITH FLAME AND HEAT PROPAGATION PREVENTION STRUCTURE AND BATTERY PACK SYSTEM INCLUDING THE SAME

(71) Applicants: Hyundai Motor Company, Seoul (KR); Kia Corporation, Seoul (KR)

(72) Inventors: Junyoung Kang, Hwaseong (KR); Juhee Kim, Hwaseong (KR); Jiwoong Jung, Hwaseong (KR); Hyunchang Kang, Hwaseong (KR)

(21) Appl. No.: 18/970,514

(22) Filed: Dec. 5, 2024

(30) Foreign Application Priority Data
Aug. 1, 2024 (KR) 10-2024-0102543

(51) Int. Cl. H01M 50/367; H01M 10/6556; H01M 50/249

(52) U.S. Cl. CPC H01M 50/367; H01M 10/6556; H01M 50/249

(57) ABSTRACT

A battery module includes: a cell array in which multiple battery cells, which store electrical energy, are overlappingly stacked; a pair of sensing boards coupled to opposite surfaces of the cell array, respectively, in which each of the battery cells has a cell terminal on at least one of opposite sides, and each of the opposite surfaces is provided with the cell terminals; at least two end plates that cover and protect a part of outer surfaces of the cell array; a bending vent array that covers the upper ends of the battery cells aligned in the cell array and forms multiple of guide flow paths along paths parallel to an imaginary line passing through the space between the sensing boards above the battery cells at the shortest distance; and a modular housing that covers and protects at least one of the outer surfaces of the cell array, including the bending vent array.

### CROSS-REFERENCE TO RELATED APPLICATION(S)

This application is based on and claims the benefit of 35 U.S.C. 119 to Korean Patent Application No. 10-2024-0102543, filed on Aug. 1, 2024, in the Korean Intellectual Property Office, the disclosure of which is herein incorporated by reference in its entirety.

### BACKGROUND

### Technical Field

The present disclosure relates to a battery module with a flame and heat propagation prevention structure and a battery pack system including the same. More specifically, the present disclosure relates to a battery module that includes a bending vent array capable of dispersing and discharging flames in each battery module including multiple battery cells, thereby preventing the propagation of flames and heat to adjacent battery cells or battery modules, and a battery pack system including the same.

### Background

Internal combustion engines have long been used as the primary power source for transportation means, such as automobiles.

The fuel for internal combustion engines is primarily fossil energy, which emits greenhouse gases during combustion and contributes to environmental issues such as global warming.

In addition, fossil energy reserves are limited, making it essential to develop alternative energy sources.

With advancements in large-capacity battery technology and improvements in electric motor performance, electric motors and batteries, which can replace internal combustion engines and fossil energy, are gradually becoming commercialized.

Electric vehicles have lower fuel costs and maintenance expenses compared to internal combustion engine vehicles. They are not only more environmentally friendly but also easier to equip with electronic driving convenience features.

However, in order for electric vehicles to replace internal combustion engine vehicles, several issues should be addressed, such as increasing battery capacity, expanding charging infrastructure, realizing fast-charging technology, and ensuring the safety of batteries, which are vulnerable to fire.

In the past, several battery cells were connected in series or parallel to form a single battery module, and the battery module included cartridge units, surface pressure pads, and the like positioned between the battery cells. In addition, heat dissipation materials and cooling channels were sometimes separately added to the battery module.

Conventional battery modules usually had a bottom surface equipped with cooling means and a structure in which separating walls formed a box-shaped space, and the top of the space was covered with a cover member.

These battery modules were densely arranged in the internal space of a housing to form a battery pack.

Conventional battery pack systems were vulnerable to fire or overheating due to their structure, where battery cells and battery modules were densely packed in a limited space.

Therefore, there was a need for technologies to solve these issues.

### SUMMARY

The present disclosure seeks to solve the problem in the prior art in which, when a flame occurs or the temperature in a battery module rises due to overheating, the flame is likely to spread to adjacent modules or the overheated air is likely to spread.

In addition, the present disclosure seeks to solve the problem in the prior art in which, because the interior of a battery module or the interior of a battery pack is not smoothly ventilated, temperature deviation is significant depending on the location inside the battery module or battery pack.

Furthermore, the present disclosure seeks to solve the problem in the prior art in which, when a thermal runaway phenomenon occurs inside a battery module or a battery pack, a case or cover may be deformed or melted.

The tasks of the present disclosure are not limited to the those mentioned above, and other tasks not mentioned above can be understood from the following description.

A battery module according to an embodiment of the present disclosure includes: a cell array in which multiple battery cells, which store electrical energy, are overlappingly stacked; a pair of sensing boards coupled to opposite surfaces of the cell array, respectively, in which each of the battery cells has a cell terminal on at least one of opposite sides, and each of the opposite surfaces is provided with the cell terminals; at least two end plates that cover and protect a part of outer surfaces of the cell array; a bending vent array that covers the upper ends of the battery cells aligned in the cell array and forms multiple of guide flow paths along paths parallel to an imaginary line passing through the space between the sensing boards above the battery cells at the shortest distance; and a modular housing that covers and protects at least one of the outer surfaces of the cell array, including the bending vent array.

In the battery module according to the embodiment of the disclosure, the sensing boards include a bus bar electrically connected to the cell terminal of each of the battery cells aligned in the cell array.

Alternatively, the battery module according to the embodiment of the disclosure includes: a heat dissipation plate configured to outwardly dissipate heat from the cell array, wherein the heat dissipation plate is a plate-shaped member in contact with bottom ends of the battery cells aligned in the cell array and is made of a material with high thermal conductivity; and a cooling channel configured to cool the heat dissipation plate.

The battery module according to the embodiment of the present disclosure includes a pair of side plates, which cover and protect outer sides of the sensing boards, respectively, and have both ends that are connected to the pair of end plates, respectively.

Alternatively, in the battery module according to the embodiment of the present disclosure, the bending vent array includes a main plate, which is a plate-shaped member and is configured to cover a top surface of the cell array by a predetermined width across a center of the top surface, and an insulating pad provided between the main plate and the cell array.

In the battery module according to the embodiment of the disclosure, the bending vent array includes a vent module cover that covers a portion between the main plate and each of the sensing boards on the top surface of the cell array, and forms multiple guide flow paths above the cell array, and a first discharge port, which is an open end of each of the guide flow paths that opens toward an upper portion of the main plate. The vent module cover includes a bending edge formed vertically above each of the pair of sensing boards, guiding airflow rising upward toward the upper portion of the main plate, a vent top, which is a plate-shaped member and is disposed horizontally with the main plate and extends from the bending edge to cover at least a portion of the main plate, and multiple partition walls, which are provided on a bottom surface of the vent top and form boundaries of the guide flow paths.

The battery module according to the embodiment of the present disclosure includes a particle filter installed between the vent top and the cell array and configured to filter out particles larger than a predetermined size.

In the battery module according to the embodiment of the disclosure, the modular housing is in contact with top surfaces of a pair of vent tops, covering the upper portion of the cell array, and forms a merging discharge path, which is a space spaced apart from the main plate and has a path orthogonal to the guide flow paths.

The battery module according to the embodiment of the present disclosure includes the bending vent array includes a guide wall formed above the main plate to divide the merging discharge path into two paths, and the guide wall protrudes upward along a longitudinal direction of the merging discharge path on a top surface of the main plate.

In the battery module according to the embodiment of the disclosure, the bending vent array includes the vent module cover coupled inside the modular housing, and the main plate attached to the top surface of the cell array together with the insulating pad.

A battery pack system according to an embodiment of the present disclosure includes: multiple battery modules; a battery pack housing, which is an enclosure having an internal space configured to accommodate the multiple battery modules; and a module boundary member including multiple horizontal partition walls and multiple vertical partition walls that partition the internal space of the battery pack housing in a grid shape. Each of the multiple battery modules is accommodated in a storage slot partitioned by the module boundary member.

In the battery pack system according to the embodiment of the present disclosure, the battery pack housing includes discharge units, each of which is installed in a linear direction of the merging discharge path formed in each of the multiple battery modules, the discharge unit being configured to discharge air to the exterior of the battery pack housing.

In the battery pack system according to an embodiment of the present disclosure, the multiple battery modules include a first-type module having a pair of primary flow paths in the merging discharge path of the bending vent array; a second-type module having, in the merging discharge path of the bending vent array, a pair of primary flow paths and a passage flow path further provided between the primary flow paths in parallel to the primary flow paths; and a third-type module only having multiple guide flow paths provided in the bending vent array.

In some embodiments, a battery module with a flame and heat propagation prevention structure comprises a cell array with a predetermined number of battery cells arranged in a stacked configuration. A pair of sensing boards is respectively coupled to opposite surfaces of the cell array, wherein each battery cell has a cell terminal on at least one of its opposing sides, and each of the opposing surfaces includes these cell terminals. The module further includes at least two end plates that cover and protect at least a part of the outer surfaces of the cell array. A bending vent array covers the upper ends of the battery cells aligned within the cell array and forms multiple guide flow paths that run parallel to an imaginary line passing through the space between the sensing boards, positioned as close as possible above the battery cells. Additionally, a modular housing covers and protects at least one outer surface of the cell array, including the bending vent array.

The sensing boards may comprise a bus bar electrically connected to the cell terminal of each of the battery cells within the cell array.

The battery module may further comprise a heat dissipation plate configured to outwardly dissipate heat from the cell array, wherein the heat dissipation plate is a plate-shaped member in contact with the bottom ends of the battery cells in the cell array, and a cooling channel configured to cool the heat dissipation plate.

The battery module may further comprise a pair of side plates that cover and protect the outer sides of the sensing boards, with each end connected to the pair of end plates.

The bending vent array may comprise a main plate, which is a plate-shaped member configured to cover a top surface of the cell array by a predetermined width across the center of the top surface, and an insulating pad provided between the main plate and the cell array.

The bending vent array may comprise a vent module cover that covers a portion between the main plate and each of the sensing boards on the top surface of the cell array and forms multiple guide flow paths above the cell array. The bending vent array may further include a first discharge port, which is an open end of each of the guide flow paths that opens toward an upper portion of the main plate. Additionally, the vent module cover may comprise a bending edge formed vertically above each of the pair of sensing boards, guiding airflow rising upward toward the upper portion of the main plate, a vent top, which is a plate-shaped member disposed horizontally with the main plate and extending from the bending edge to cover at least a portion of the main plate, and multiple partition walls provided on the bottom surface of the vent top that form boundaries of the guide flow paths.

The battery module may further comprise a particle filter installed between the vent top and the cell array and configured to filter out particles larger than a predetermined size.

The modular housing may be in contact with the top surfaces of a pair of vent tops, covering the upper portion of the cell array, and forming a merging discharge path, which is a space spaced apart from the main plate with a path orthogonal to the guide flow paths.

The bending vent array may comprise a guide wall formed above the main plate to divide the merging discharge path into two paths, wherein the guide wall protrudes upward along the longitudinal direction of the merging discharge path on the top surface of the main plate.

The bending vent array may comprise the vent module cover coupled inside the modular housing, with the main plate attached to the top surface of the cell array together with the insulating pad.

In some embodiments, a battery pack system comprises multiple battery modules, each configured according to one or more of the preceding embodiments. The battery pack system includes a battery pack housing, which is an enclosure having an internal space configured to accommodate the multiple battery modules, and a module boundary member comprising multiple horizontal partition walls and multiple vertical partition walls that partition the internal space of the battery pack housing in a grid shape. Each of the multiple battery modules is accommodated in a storage slot partitioned by the module boundary member.

The battery pack housing may comprise discharge units, each of which is installed in a linear direction of the merging discharge path formed in each of the multiple battery modules, with each discharge unit configured to discharge air to the exterior of the battery pack housing.

The multiple battery modules may include a first-type module having a pair of primary flow paths in the merging discharge path of the bending vent array, a second-type module having, in the merging discharge path of the bending vent array, a pair of primary flow paths and an additional passage flow path positioned between the primary flow paths in parallel to them, and a third-type module having multiple guide flow paths provided in the bending vent array.

In some embodiments, a battery module with a flame and heat propagation prevention structure comprises a cell array formed by stacking multiple battery cells. A modular cover is positioned above a bending vent array, and the modular cover has a pair of clastic coupling pieces extending downward to engage with both ends of a guide wall. The bending vent array includes multiple guide flow paths positioned above the cell array, each guide flow path containing a particle filter configured to prevent particles larger than a predetermined size from passing through. The guide wall is positioned along a merging discharge path within the battery module, dividing the merging discharge path into separate fluid flow paths on either side of the guide wall. The merging discharge path directs fluid discharged from the guide flow paths away from the cell array. Additionally, a heat dissipation plate is positioned below the cell array, and the heat dissipation plate includes a cooling channel configured for cooling the cell array by conducting liquid or air. A modular housing covers the modular cover, bending vent array, and heat dissipation plate, providing impact protection to the battery module.

The battery module may include a guide wall in the merging discharge path that is secured by the clastic coupling pieces pressing from both sides of the guide wall, thereby fixing the modular cover above the bending vent array.

The modular housing may include a horizontal protective top plate and protective side plates that contact outer surfaces of end plates and/or side plates surrounding the cell array, forming a box-shaped enclosure for impact protection.

In some embodiments, a battery pack system comprises multiple battery modules, each with a merging discharge path that includes primary flow paths to allow fluid to exit each module and a passage flow path located between the primary flow paths to create a dedicated path for heat or flame to exit the battery module. A battery pack housing contains the battery modules, with discharge units installed along the housing and configured to discharge fluid from the merging discharge path of each module to the exterior of the battery pack housing. A module boundary member within the battery pack housing comprises multiple horizontal and vertical partition walls that define storage slots in a grid shape for each battery module. Each storage slot is configured to receive one battery module and includes at least one conductive unit for electrical connection and at least one management unit for cooling, buffering, or monitoring of the battery module. A module pass is positioned within the module boundary member, connecting merging discharge paths between adjacent battery modules to direct high-temperature gas or flames along predetermined paths, and preventing heat from one module from spreading to adjacent modules.

The merging discharge path in each battery module may include at least one bending wall to guide fluid flow from the guide flow paths toward the outlet of the merging discharge path.

Each discharge unit installed in the battery pack housing may be positioned along a linear path aligned with the merging discharge paths in each battery module, such that each discharge unit discharges fluid along an orthogonal path relative to the flow direction of guide flow paths within the battery module.

The battery modules in the battery pack system may include a first-type module with primary flow paths extending in parallel along the merging discharge path, a second-type module with primary flow paths and a passage flow path positioned between the primary flow paths, and a third-type module with multiple guide flow paths directed above the cell array, each guide flow path configured to direct fluid toward the merging discharge path.

According to the present disclosure, flames or heat generated in certain battery modules or battery cells are prevented from being propagated or spread to adjacent battery modules or battery cells.

According to the present disclosure, ventilation of the internal space in a battery module or a battery pack system including the same is evenly achieved, facilitating easier control of the internal temperature of the battery module and the battery pack system.

According to the present disclosure, thermal runaway that may occur in a battery module or a battery pack system can be significantly reduced.

According to the present disclosure, even if thermal runaway occurs, flames and heat can be quickly vented to the exterior, thereby preventing structural deformation or damage of the battery module and the battery pack system, as well as the battery housing.

As discussed, the method and system suitably include use of a controller or processer.

In another embodiment, vehicles are provided that comprise an apparatus as disclosed herein.

The effects of the present disclosure are not limited to those mentioned above, and other effects not mentioned will be clearly understood by those ordinarily skilled in the art from the following description.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is an exploded perspective view illustrating a battery module according to an embodiment of the present disclosure;

FIG. 2 is a perspective view illustrating a battery module according to an embodiment of the present disclosure;

FIG. 3 is a cross-sectional view taken along line A-A′ in FIG. 2;

FIG. 4 is a cross-sectional view taken along line A-A′ in FIG. 2, illustrating a state in which a particle filter is provided on a guide flow path formed through a bending vent array;

FIG. 5 is a perspective view illustrating a bending vent array in the battery module according to an embodiment of the present disclosure;

FIG. 6 is an exploded perspective view illustrating the bending vent array in the battery module according to an embodiment of the present disclosure;

FIG. 7 illustrates a cross-sectional view and a partially enlarged view of a state in which a modular cover is coupled above the bending vent array in the battery module according to an embodiment of the present disclosure;

FIG. 8 illustrates cross-sectional views taken along line B-B′ in FIG. 2, primary flow paths provided in each battery module;

FIG. 9 is a schematic view illustrating the state in which paths for guiding flames between adjacent battery modules in a battery pack system according to an embodiment of the present disclosure are separated from each other, and

FIG. 10 is a cross-sectional view illustrating paths of merging discharge paths formed inside a battery pack housing in a battery pack system according to an embodiment of the present disclosure.

### DETAILED DESCRIPTION OF THE EXEMPLARY EMBODIMENTS

Hereinafter, embodiments disclosed herein will be described in detail with reference to the accompanying drawings. Identical or similar components are given the same or similar reference numerals, and duplicate descriptions may be omitted.

When a component is described as being “connected” or “coupled” to another component, it means that the component may be directly connected or coupled to the other component, or there may be another component in between. On the other hand, when a component is described as being “directly connected” or “directly coupled”, it means that there are no other components in between.

As used herein, the terms “include” or “have” indicate the presence of features, steps, operations, components, parts, or combinations thereof described herein, but do not exclude any of them.

The first direction X, second direction Y, and third direction Z described herein represent the dimensions and directionalities on a three-dimensional coordinate system used to express a three-dimensional shape. Therefore, the first direction X, second direction Y, and third direction Z each refer to directions defined in mutually orthogonal dimensions.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure discloses a battery module with a flame and heat propagation prevention structure and a battery pack system 1 including the same.

The elements that constitute the electric battery pack system 1 are generally expressed by terms such as cell, module, and pack.

A battery cell 110 is a basic component of the electric battery pack system 1 and plays a role in storing and releasing electricity.

The method in which the battery cell 110 stores and releases electricity may be implemented in various ways. For example, the battery cell 110 may be a lithium-ion cell. In this case, each of the battery cells 110 may include a positive electrode that releases lithium ions, a negative electrode that stores lithium ions, an electrolyte that enables the movement of lithium ions, and a separator that allows only ions to move while preventing the positive and negative electrodes from making direct contact.

A battery module 100 refers to a unit in which multiple battery cells 110 are combined. Multiple battery cells 110 are each connected in series or parallel to form a single battery module 100. The battery module 100 includes a cell array in which the multiple battery cells 110 are stacked, and the cell array may be accommodated in a protective case or a heat dissipation plate 180.

The battery pack system 1 includes multiple battery modules 100. The battery pack system 1 is the final unit that supplies electric energy to a power device such as a motor, and in the case of an electric vehicle, the battery pack system 1 may be mounted at the bottom or rear of the vehicle.

The battery pack system 1 may include a battery pack housing 600 that accommodates the battery modules 100, a management part that monitors and manages the battery modules 100 inside the battery pack housing 600, a cooling part that controls the temperature inside the battery pack housing 600, and a protector that physically protects the battery module 100.

A battery module with a flame and heat propagation prevention structure according to an embodiment of the present disclosure is described.

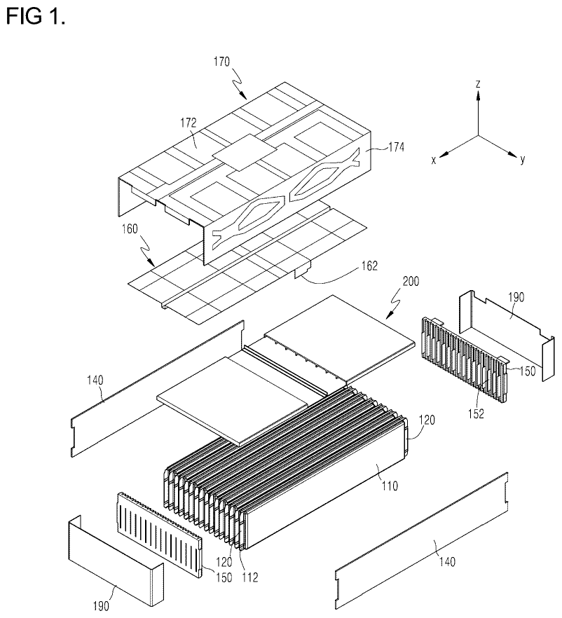

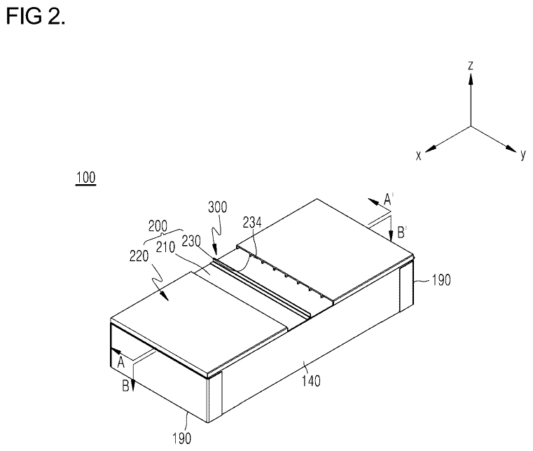

FIG. 1 is an exploded perspective view illustrating a battery module according to an embodiment of the present disclosure, and FIG. 2 is a perspective view illustrating a battery module according to an embodiment of the present disclosure.

As illustrated in FIGS. 1 and 2, the battery module 100 according to an embodiment of the present disclosure may include a cell array, sensing boards 150, end plates 140, a bending vent array 200, and a modular housing 170.

The cell array is formed by stacking multiple battery cells 110. The cell array is formed in a form in which a predetermined number of battery cells 110 are regularly arranged. A cell cartridge 120 or a pad that acts as a buffer may be included between each adjacent battery cells 110. The cell cartridge 120 may also serve as an electrolyte layer or a separator. Each battery cell 110 may have a thin plate shape, and as illustrated in FIG. 1, at least one cell terminal 112 may be provided on one side or both sides of each battery cell 110.

As illustrated, multiple cell terminals 112 may be provided on both side surfaces of the cell array that is horizontal to the Y-Z plane. One surface of the sensing board 150 may be equipped with several bus bars. A cell terminal 112 may be fitted to each bus bar, and the battery cells 110 constituting the cell array may be electrically connected to each other through the bus bars provided on the sensing boards 150. The sensing boards 150 may be respectively connected to both side surfaces of the cell array.

The end plates 140 are structures that at least partially cover and protect the outer surfaces of the cell array. The end plates 140 may be plate-shaped members and may be made of a highly rigid material that is not easily deformed by heat or moisture.

Specifically, a pair of end plates 140 are connected to cover two surfaces of the cell array that are parallel to the X-Z plane based on FIG. 1.

The bending vent array 200 disposed above the cell array. The bending vent array 200 covers the top surface of the cell array and forms multiple guide flow paths 232 along the upper sides of respective battery cells 110. The guide flow paths 232 are passages surrounded by the top surface of the cell array and the bending vent array 200.

The multiple guide flow paths 232 formed inside the bending vent array 200 may be formed in a number corresponding to the number of battery cells 110.

Each of the guide flow paths 232 forms a path along the top surface of the corresponding battery cell 110, and the number of guide flow paths 232 may be equal to the number of battery cells 110. Based on the virtual straight line passing through the pair of sensing boards 150 at the shortest distance, the guide flow paths 232 have paths parallel to this virtual straight line.

In an embodiment of the present disclosure, the battery module 100 may further include a modular cover 160 and/or a modular housing 170. The modular cover 160 is a plate-shaped member that covers and protects the bending vent array 200 from above and serves the role of primarily redirecting the air discharged through the guide flow paths 232 formed in the bending vent array 200, and responding to the momentary increase in internal pressure.

The modular housing 170 may be provided to cover and protect a portion of the top and side surfaces of the cell array. The modular housing 170 protects the cell array accommodated inside from physical impact and forms the outer shape of the battery module 100.

The modular cover 160, the bending vent array 200, and the cell array may be sequentially positioned under the modular housing 170, and the bending vent array 200 may be directly coupled to the inner surface of the modular housing 170.

As illustrated in FIG. 2, four side surfaces of the cell array of the battery module 100 may be covered and protected by a pair of end plates 140 and a pair of side plates 190. The pair of end plates 140 and the pair of side plates 190 can be coupled to each other on opposite sides to define a box-shaped space, and the cell array, which is coupled to the sensing boards 150 on the opposite sides, may be accommodated in this box-shaped space.

A heat dissipation plate 180 may be provided on the bottom surface of the cell array. The heat dissipation plate 180 releases heat generated in the cell array to the outside. The heat dissipation plate 180 may be additionally provided with a cooling channel that cools the heat dissipation plate 180 by water cooling or air cooling.

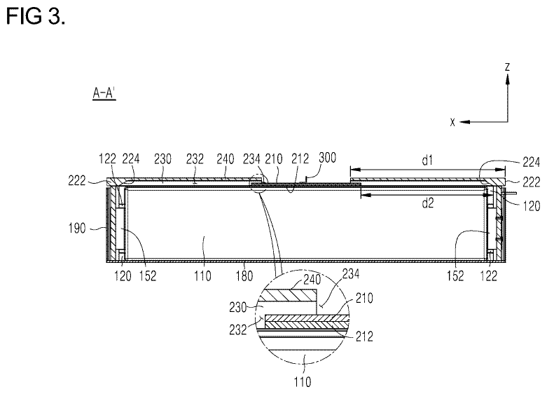

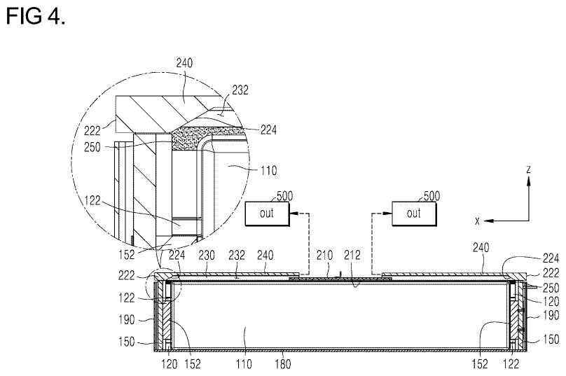

FIGS. 3 and 4 are cross-sectional views taken along line A-A′ of FIG. 2, which illustrate a state in which a particle filter 250 is provided on the guide flow paths 232 formed through the bending vent array 200.

As illustrated in FIGS. 3 and 4, the heat dissipation plate 180 forms the bottom surface, and the cell array is accommodated in the space surrounded by the pair of end plates 140 and the pair of side plates 190. The cell array is accommodated in the space surrounded by the heat dissipation plate 180, the end plates 140, and the side plates 190, with the sensing boards 150 coupled to both sides.

The bending vent array 200 is installed above the cell array. Multiple guide flow paths 232 are formed in the space between the bending vent array 200 and the cell array.

The bending vent array 200 may include main plates 210, insulating pads 212, and vent module covers 220. The main plates 210 are plate-shaped members having a predetermined width and length and has a relatively small thickness.

The main plates 210 may be made of a material with non-flammable or flame-retardant properties and may be formed of a material with low thermal conductivity and high durability.

The main plates 210 are disposed across the central portion of the top surface of the cell array.

The main plates 210 are disposed horizontally with the X-Y plane and are installed to cover a middle portion of the top surface of the cell array. A portion of the top surface of the cell array is covered with the main plates 210.

Specifically, the main plates 210 are horizontally placed on a portion of the central portion of the top surface of the cell array. Based on the central area covered by the main plates 210 on the top surface of the cell array, the top surface of the cell array is exposed upward on both sides of the main plates 210. That is, the top surface portions of the cell array between the main plates 210 and the sensing boards 150 are exposed upward.

A pair of vent module covers 220 are respectively provided on both sides of the main plates 210 and cover the top surface of the cell array on both sides of the main plates 210.

Specifically, the vent module covers 220 are in contact with the upper ends of the end plates 140 and the upper ends of the side plates 190 and may bending edges 222 that respectively extend upward alongside the end plates 140 and the side plates 190.

The bending edges 222 extend upward, being in contact with the upper edges of the side plates 190 and, by a predetermined length, with the upper edges of the end plates 140, which are connected to both sides of the side plates 190.

The bending edges 222 may be in contact with the upper ends of the side plates 190 and a portion of the end plates 140 where their lower end portions contact and may be sealed along the contact surfaces.

The inner surfaces of the bending edges 222 may have inclined surfaces or curved surfaces 224, which are formed vertically above the cell terminals 112 of the cell array and/or the sensing boards 150.

The curved surfaces 224 may be formed at the points where the fluid rising from below collides with the bottom surfaces of vent tops 240 and may guide the rising fluid to smoothly change its direction and flow along the curved surfaces 224 formed below the vent tops 240.

The vent tops 240 are plate-shaped members and may have a relatively small thickness. The vent tops 240 are disposed on a plane parallel to the main plate 210 and spaced apart from the top surface of the cell tray, so that a predetermined space is formed therebetween.

Specifically, the vent tops 240 are disposed at a higher position than the main plate 210. The vent tops 240 are formed so as to cover a portion of the top surface of the main plate 210, and three sides, except for the side facing the main plate 210, are connected along their longitudinal direction to be orthogonal to the upper ends of the bending edges 222.

The pair of vent module covers 220 may at least partially overlap the main plate 210 along both side edges of the main plate 210 and extend above the main plate 210 to respectively cover portions of both sides of the top surface of the main plate 210.

Each vent module cover 220 is a plate-shaped member, partially overlapping one of both side portions of the main plate 210 and includes a vent top 240 positioned higher than the main plate 210. The vent tops 240 may be rectangular plate-shaped members. The vent module covers 220 may further include bending edges 222 that extend downward along three sides of the vent tops 240 to form walls, which are connected to the upper ends of the side plates 190 and the upper ends of the end plates 140.

Multiple partition walls 230 are provided on the bottom surfaces of the vent tops 240.

The partition walls 230 extend from the bottom surfaces of the vent tops 240 toward the space surrounded by the vent tops 240 and the bending edges 222. The partition walls 230 are arranged in parallel, and the spaces between the partition walls 230 form guide flow paths 232 through which gas can flow. The guide flow paths 232 have paths parallel to an imaginary straight line that connects the sensing boards 150 in the shortest distance, and each guide flow path 232 serves as a passage for discharging flames or heat generated from each battery cell 110 forming the cell array, the spaces between the battery cells 110, and the portions where the cell terminals 112 provided in the battery cells 110 are connected to the sensing boards 150.

The guide flow paths 232 include first discharge ports 234 formed to allow fluid to be discharged toward the upper portion of the main plate 210, which is the central portion of the cell array.

Particle filters 250 may be installed between the cell array under the vent module covers 220 and the partition walls 230. The particle filters 250 may be in the form of a mesh and block objects larger than a predetermined size, including flame particles, from entering the guide flow paths 232 from the air flowing from the cell array into the guide flow paths 232 between the partition walls 230.

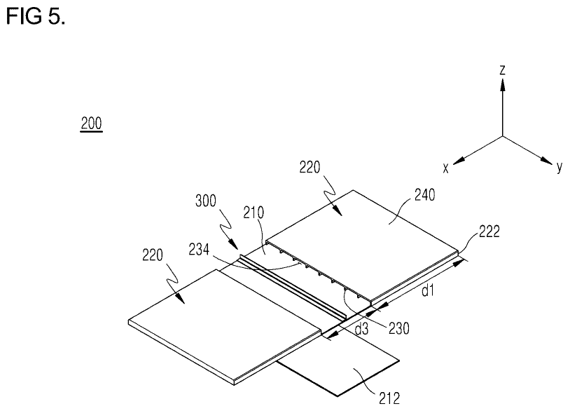

FIG. 5 is a perspective view illustrating a bending vent array 200 in a battery module 100.

As illustrates in FIG. 5, the vent module covers 220 provided on both sides of the main plate 210 may include first discharge ports 234 formed at the ends of the guide flow paths 232.

The first discharge ports 234 are outlets through which fluid that has passed through the guide flow paths 232 is discharged toward the upper portion of the main plate 210.

The multiple first discharge ports 234 formed in the pair of vent module covers 220 may be disposed to face each other toward the upper portion of the main plate 210.

Therefore, when the cell terminals 112 of the cell array or a cell cartridge 120 overheat or a flame occurs at a specific location, the high-temperature gas or flame is guided to the upper center of the battery module 100 through the adjacent guide flow paths 232, which branch into multiple paths.

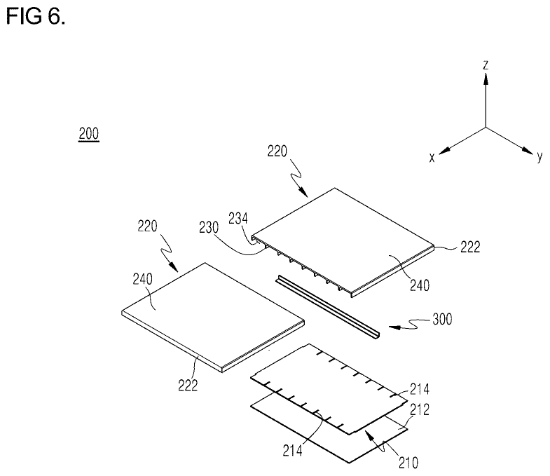

FIG. 6 is an exploded perspective view illustrating the bending vent array 200 in the battery module 100.

As illustrated in FIG. 6, a merging discharge path is the space between the vent module covers 220. The merging discharge path is a passage with the bottom surface formed by the main plate 210.

The longitudinal direction of the path formed by the merging discharge path is orthogonal to the path direction of the guide flow paths 232. The merging discharge path is a predetermined space and passage formed above the main plates 210, between the first discharge ports 234 of the vent module covers 220 that face each other.

The merging discharge path runs parallel to the Y-axis direction and forms a fluid path orthogonal to the paths formed in the guide flow paths 232.

A guide wall 300, which is a wall that divides the merging discharge path into two separate paths along its longitudinal direction, may be further provided above the main plates 210.

The guide wall 300 may be a wall extending upward along the center of the main plates 210 and may be fixed by attachment or coupling to the top surfaces of the main plates 210.

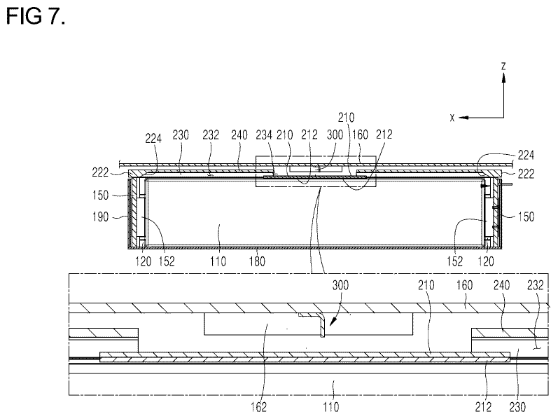

FIG. 7 illustrates a cross-sectional view and a partially enlarged view of a state in which a modular cover is coupled above the bending vent array.

As illustrated in FIG. 7, the guide wall 300 may be implemented in a form extending downward from the bottom surface of the modular cover 160 or the modular housing 170, which is coupled to cover the upper side of the bending vent array 200.

The guide wall 300 is provided as a linear wall on the merging discharge path and serves to divide the fluid flow path into two on both sides.

The guide wall 300 may be fixed by attachment or coupling to the bottom surface of the modular cover 160. Alternatively, the guide wall may be fixed by attachment or coupling to the bottom surface of the modular housing 170.

The modular cover 160 may include a pair of elastic coupling pieces 162 extending downward at positions corresponding to both ends of the guide wall 300.

When the modular cover 160 is installed above the bending vent array 200 to form the battery module 100, both ends of the guide wall 300 may correspond to and be coupled with a pair of elastic coupling pieces 162.

Both ends of the guide wall 300 may be respectively attached to the facing surfaces of the elastic coupling pieces 162 through welding or may remain firmly fixed by external force applied by the elastic coupling pieces 162 pressing from both sides.

Through the pair of elastic coupling pieces 162 provided in the modular cover 160, the bending vent array 200 may be fixed above the cell array.

In this case, the bending vent array 200 may be coupled to the modular cover 160 through the pair of elastic coupling pieces 162, and the modular cover 160 may form the top surface of the battery module 100 by being in contact with the upper edges of the end plates 140 and the side plates 190 surrounding the cell array.

The modular cover 160 may be optionally provided according to an embodiment.

The modular housing 170 may include a horizontal protective top plate 172 parallel to the bending vent array 200, and protective side plates 174 that come into contact with at least part of the outer surfaces of the pair of end plates 140 and/or the pair of side plates 190.

The modular housing 170 may cover the top of the modular cover 160. Alternatively, when the modular cover 160 is not provided, the modular housing may cover the top of the bending vent array 200, forming the outer shape of the battery module 100, including the top surface.

The bending vent array 200 may also be attached or coupled and fixed between the protective side plates 174 of the modular housing 170.

The side plates 190, the end plates 140, the modular cover 160, the modular housing 170, and the bending vent array 200 that form the battery module 100 may each be coupled by welding or may be fixedly connected and coupled to each other through separate fastening members.

According to an embodiment, the fastening members or fastening methods may be implemented in various forms such as bolts, clamps, rivets, pins, or welding. In addition, brackets in the shape of an “L”, “T”, or “U” may be added to the joints between the end plates 140, the side plates 190, the modular cover 160, the modular housing 170, and the bending vent array 200 for connection and fixation.

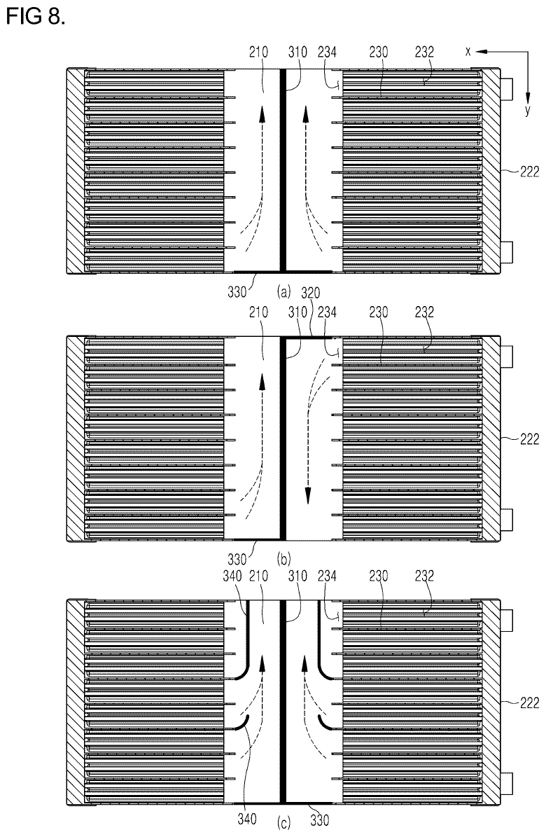

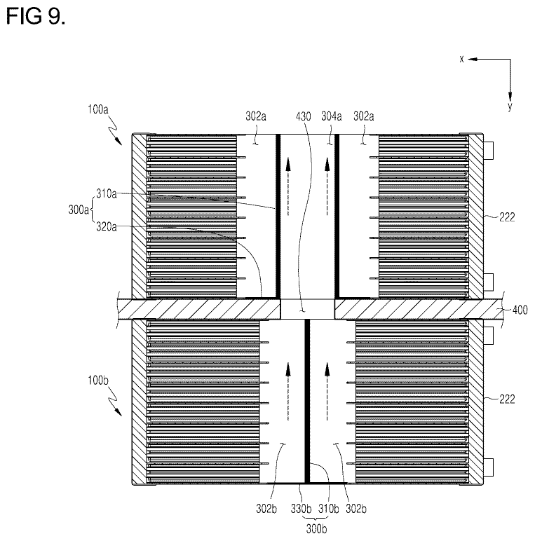

FIG. 8 illustrates cross-sectional views, each of which illustrates primary flow paths formed in each battery module, and FIG. 9 is a schematic view illustrating the state in which flame guide paths between adjacent battery modules in a battery pack system are separated.

As illustrated in FIGS. 8 and 9, a battery module 100 includes a merging discharge path. The merging discharge path is a space formed on the top of each cell array, allowing gas to flow across the center of the top of the cell array and exit the battery module 100.

The merging discharge path may include primary flows path 302 and a passage flow path 304.

The primary flow paths 302 refer to the flow paths directly connected to the first discharge ports 234 formed in respective guide flow paths 232. The passage flow path 304 refers to a fluid flow path that is formed between the primary flow paths 302 and includes an inlet through which fluid can enter each battery module 100 and an outlet through which the fluid that has entered the inlet can move along a straight path to be discharged.

As illustrated in (a) of FIG. 8, the merging discharge path may be divided into two primary flow paths 302 by the guide wall 300. A center wall 310 may be formed along the center of the merging discharge path, dividing it into two parallel primary flow paths 302. A multi-barrier 330 may be provided to close one end of the merging discharge path so that the fluid flow through the two primary flow paths 302 is formed in the same direction.

As illustrated in (b) of FIG. 8, the merging discharge path may also be divided into two primary flow paths 302 by the guide wall 300, and respective primary flow paths 302 may be formed to allow fluid to flow in opposite directions.

Specifically, the guide wall 300 may include the center wall 310, which partitions the merging discharge path into two spaces, and a block wall 320, which blocks one end of the primary flow paths 302.

The two primary flow paths 302 formed by the center wall 310 respective have the block walls 320 oriented in opposite directions, allowing the fluid discharged from the guide flow paths 232 on opposite sides to flow in opposite directions.

As illustrated in (c) of FIG. 8, at least one bending wall 340 may be formed in the primary flow paths 302, and the bending wall 340 naturally guides the fluid discharged from the first discharge ports 234 of the guide flow paths 232 in the direction of the outlets of the primary flow paths 302.

The guide wall 300 may be applied to both a first-type module and a second-type module. The battery module 100 of the first-type module is provided with a guide wall 300 at the center of the top of the main plate 210, and the merging discharge path forms two parallel primary flow paths 302 branched by the guide wall 300.

The battery module 100 of the second-type module may be classified as a case where two parallel center walls 310 are provided on the top of the main plates 210.

As illustrated in FIG. 9, a passage flow path 304a may be provided between two parallel linear center walls 310a. On both sides of the through flow path 304a, a pair of primary flow paths 302a parallel to the passage flow path 304a may be formed.

The passage flow path 304 includes an inlet through which fluid enters each battery module 100 and an outlet through which the fluid that has entered is discharged after passing through the battery module 100, in which the inlet and outlet of the through flow path 304a are connected by a linear fluid flow path.

The passage flow path 304a may be applied to the battery pack system 1 that accommodates multiple battery modules 100.

The passage flow path 304a guides the flame or heat generated in the adjacent battery module 100b to be discharged through an independent path.

Therefore, a structure is formed in which the flame or heat generated in the adjacent battery module 100b does not propagate to or enter the surrounding battery module 100a or battery cells 110a. The battery module 100 of a third-type module may be defined as a case where one vent module cover 220 is provided, only forming multiple guide flow paths 232 parallel to the space above the cell array.

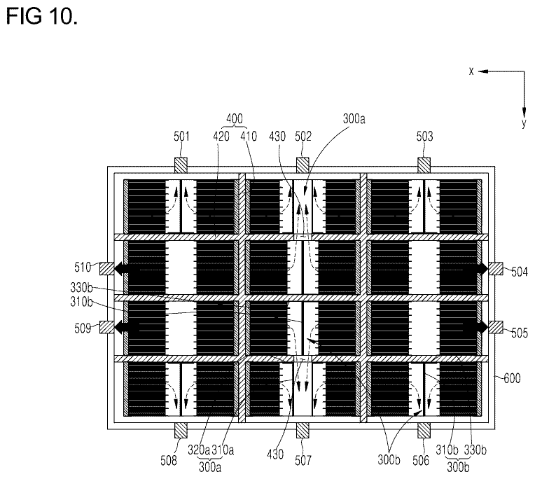

FIG. 10 is a cross-sectional view illustrating paths of merging discharge paths formed inside a battery pack housing in a battery pack system.

As illustrated in FIG. 10, the battery pack system 1 is a system in which multiple battery modules 100 are combined and accommodated.

The battery pack system 1 may include a battery pack housing 600, a module boundary member 400, and a discharge unit 500.

The battery pack housing 600 defines a space in which multiple battery modules 100 can be regularly accommodated. The module boundary member 400 may include multiple horizontal partition walls 410 and vertical partition walls 420 that divide the internal space of the battery pack housing 600 into a grid shape.

Multiple layers of module boundary members 400 may be provided, and a boundary member having heat dissipation, cooling, and buffering functions may be interposed between each two adjacent layers.

The module boundary members 400 may each include a module pass 430 that partially opens between the merging discharge paths formed in the adjacent battery modules 100 to connect the merging discharge paths.

Through the module boundary members 400, multiple storage slots may be formed inside the battery pack housing 600.

The storage slots refer to independent spaces partitioned by the module boundary members 400 and are formed in rows, columns, and layers within the battery pack housing 600. Each battery module 100 may be accommodated in one of the storage slots.

Each storage slot may further include a conductive unit for electrically connecting the mounted battery module 100 and a management unit for performing functions such as cooling, buffering, heat dissipation, and status monitoring of the battery module 100.

The battery pack system 1 includes multiple discharge units 500 corresponding to the merging discharge paths formed in the multiple battery modules 100. The discharge units 500 may be installed at regular intervals along the outer perimeter of the battery pack housing 600.

The battery modules 100, which are respectively accommodated in the storage slots formed inside the battery pack housing 600, may configured as one of the first-type module, the second-type module, and the third-type module.

In the battery pack system 1, multiple discharge units 500 may be installed in the battery pack housing 600, and each discharge unit 500 is installed in the linear path of the merging discharge path formed in a battery module 100, discharging internal air to the outside of the battery pack housing 600.

The inlet, fluid flow path, and outlet formed in each merging discharge path are provided with a discharge unit 500 to correspond to each battery module 100 in a linear path connected by an imaginary line

In the foregoing, the embodiments of the present disclosure have been described with reference to the drawings. These are exemplary, and the present disclosure is not limited to the described embodiments and the contents of the drawings.

It is evident that modifications can be made within the scope of the disclosed technical concepts.

The described embodiments should be regarded as part of the present disclosure, and the scope of the present disclosure is not limited to the described embodiments.

The scope of the present disclosure should be determined by the technical concepts described in the claims.

Even if the functions or effects of the configurations described in the embodiments are not explicitly stated, any predictable functions or effects by such configurations are included within the scope of the present disclosure.

1. A battery module with a flame and heat propagation prevention structure, the battery module comprising:
a cell array with a predetermined number of battery cells arranged in a stacked configuration;
a pair of sensing boards respectively coupled to opposite surfaces of the cell array, wherein each battery cell has a cell terminal on at least one of its opposing sides, and each of the opposing surfaces includes these cell terminals;
at least two end plates that cover and protect at least a part of outer surfaces of the cell array;
a bending vent array that covers the upper ends of the battery cells aligned in the cell array and forms multiple guide flow paths that run parallel to an imaginary line passing through the space between the sensing boards, positioned as close as possible above the battery cells; and
a modular housing that covers and protects at least one outer surface of the cell array, including the bending vent array.

2. The battery module of claim 1, wherein the sensing boards comprise a bus bar electrically connected to the cell terminal of each of the battery cells within the cell array.

3. The battery module of claim 1, further comprising:
a heat dissipation plate configured to outwardly dissipate heat from the cell array, wherein the heat dissipation plate is a plate-shaped member in contact with bottom ends of the battery cells within the cell array; and
a cooling channel configured to cool the heat dissipation plate.

4. The battery module of claim 1, further comprising:
a pair of side plates that cover and protect the outer sides of the sensing boards, with each end connected to the pair of end plates.

5. The battery module of claim 1, wherein the bending vent array comprises:
a main plate which is a plate-shaped member and is configured to cover a top surface of the cell array by a predetermined width across a center of the top surface; and
an insulating pad provided between the main plate and the cell array.

6. The battery module of claim 5, wherein the bending vent array comprises:
a vent module cover that covers a portion between the main plate and each of the sensing boards on the top surface of the cell array, and forms multiple guide flow paths above the cell array; and
a first discharge port, which is an open end of each of the guide flow paths that opens toward an upper portion of the main plate, and
wherein the vent module cover comprises:
a bending edge formed vertically above each of the pair of sensing boards, guiding airflow rising upward toward the upper portion of the main plate;
a vent top, which is a plate-shaped member and is disposed horizontally with the main plate and extends from the bending edge to cover at least a portion of the main plate; and
multiple partition walls which are provided on a bottom surface of the vent top and form boundaries of the guide flow paths.

7. The battery module of claim 6, further comprising:
a particle filter installed between the vent top and the cell array and configured to filter out particles larger than a predetermined size.

8. The battery module of claim 6, wherein the modular housing is in contact with top surfaces of a pair of vent tops, covering the upper portion of the cell array, and forms a merging discharge path, which is a space spaced apart from the main plate and with a path orthogonal to the guide flow paths.

9. The battery module of claim 8, wherein the bending vent array comprises a guide wall formed above the main plate to divide the merging discharge path into two paths, and
wherein the guide wall protrudes upward along a longitudinal direction of the merging discharge path on a top surface of the main plate.

10. The battery module of claim 6, wherein the bending vent array comprises the vent module cover coupled inside the modular housing, and the main plate attached to the top surface of the cell array together with the insulating pad.

11. A battery pack system comprising:
a) one or more multiple battery modules according to claim 1;
b) a battery pack housing, which is an enclosure having an internal space configured to accommodate the multiple battery modules; and
c) a module boundary member comprising multiple horizontal partition walls and multiple vertical partition walls that partition the internal space of the battery pack housing in a grid shape,
wherein each of the multiple battery modules is accommodated in a storage slot partitioned by the module boundary member.

12. The battery pack system of claim 11, wherein the battery pack housing comprises discharge units, each of which is installed in a linear direction of the merging discharge path formed in each of the multiple battery modules, the discharge unit being configured to discharge air to an exterior of the battery pack housing.

13. The battery pack system of claim 12, wherein the multiple battery modules comprise:
a first-type module having a pair of primary flow paths in the merging discharge path of the bending vent array;
a second-type module having, in the merging discharge path of the bending vent array, a pair of primary flow paths and a passage flow path further provided between the primary flow paths in parallel to the primary flow paths; and
a third-type module having multiple guide flow paths provided in the bending vent array.

14. A battery module with a flame and heat propagation prevention structure, the battery module comprising:
a cell array formed by stacking multiple battery cells;
a modular cover positioned above a bending vent array, the modular cover having a pair of elastic coupling pieces extending downward to engage with both ends of a guide wall;
a bending vent array including multiple guide flow paths positioned above the cell array, each guide flow path including a particle filter configured to prevent particles larger than a predetermined size from passing through;
the guide wall positioned along a merging discharge path within the battery module, dividing the merging discharge path into separate fluid flow paths on either side of the guide wall, wherein the merging discharge path directs fluid discharged from the guide flow paths away from the cell array;
a heat dissipation plate positioned below the cell array, the heat dissipation plate including a cooling channel configured for cooling the cell array by conducting liquid or air; and
a modular housing covering the modular cover, bending vent array, and heat dissipation plate, providing impact protection to the battery module.

15. The battery module of claim 14, wherein the guide wall in the merging discharge path is secured by the elastic coupling pieces pressing from both sides of the guide wall, fixing the modular cover above the bending vent array.

16. The battery module of claim 15, wherein the modular housing includes a horizontal protective top plate and protective side plates that contact outer surfaces of the end plates and/or side plates surrounding the cell array, forming a box-shaped enclosure for impact protection.

17.-20. (canceled)
